(19) United States
(12) Patent Application Publication
(10) Pub. No.: US 2016/0001237 A1
(43) Pub. Date: Jan. 7, 2016

(54) ASYMMETRICALLY POROUS MEMBRANES MADE OF CROSS-LINKED THERMOPLASTIC SILICONE ELASTOMER

(71) Applicant: WACKER CHEMIE AG, Müenchen (DE)

(72) Inventor: Tobias HALBACH, Muenchen (DE)

(21) Appl. No.: 14/769,481

(22) PCT Filed: Feb. 19, 2014
(86) PCT No.: PCT/EP2014/053234

§ 371 Date: Aug. 21, 2015

(30) Foreign Application Priority Data
Feb. 26, 2013 (DE) 10 2013 203 129.7

(51) Int. Cl. B01D 71/80; B01D 67/00; B01D 69/10; B01D 69/02; C02F 1/44; B01D 69/12; C08J 9/228; B01D 61/02

(52) U.S. Cl. CPC B01D 71/80; C08J 9/228; B01D 67/0006; B01D 61/025; B01D 69/02; C02F 1/441; B01D 69/125; B01D 69/10; B01D 2325/022; C02F 2103/08

(57) ABSTRACT

The invention relates to a covalently cross-linked, asymmetrically porous membranes (M) made of thermoplastic silicone elastomers; a method for producing the covalently cross-linked, asymmetrically porous membranes (M), in which, in a first step, a solution of a silicone composition SZ, which contains thermoplastic silicone elastomer S1 with alkenyl groups and contains cross-linker V, and a solvent L is produced, in a second step, the solution is brought into a mold, in a third step, the solution brought into a mold is brought into contact with a precipitation medium F, wherein a covalently non-cross-linked membrane is formed. In a fourth step, the solvent L and the precipitation medium F are removed from the non-cross-linked membrane and, in a fifth step, the membrane is subjected to a cross-linking, wherein the covalently cross-linked membrane M is formed; the membranes (M) produced according to the method; and to the use of the membranes (M) for the separation of material mixtures or for coating.

The invention relates to a method for producing crosslinked porous membranes having an asymmetric pore structure from thermoplastic silicone elastomer, and also to the membranes obtainable accordingly and to the use thereof.

Separating mixtures with membranes is usually more energy-efficient than with conventional separation techniques, such as fractional distillation or chemical adsorption, for example. The search for new membranes with a longer lifetime, improved selectivities, better mechanical properties, a higher flow transit rate, and low costs are significant aspects of current membrane research.

Porous membranes with an asymmetric construction for the separation of a very wide variety of mixtures are known in the literature. For instance, U.S. Pat. No. 3,133,137, U.S. Pat. No. 3,133,132, and U.S. Pat. No. 4,744,807 describe the production and the use of asymmetrically constructed cellulose acetate membranes which are produced by the phase inversion process. The process is likewise termed the Loeb-Sourirajan process. Membranes fabricated accordingly have a porous substructure and a selective layer. The thin outer layer is responsible for the separation performance, while the porous substructure gives the membranes mechanical stability. Membranes of this kind find use in reverse osmosis plants for extracting drinking water or ultrapure water from salt or brackish water.

The use of silicones as membrane material is likewise state of the art. Silicones are rubberlike polymers having a low glass transition point (Tg<-50° C.) and a high fraction of free volume in the polymer microstructure. GB1536432 and U.S. Pat. No. 5,733,663 describe the production of membranes based on silicones. Applications described include both pervaporation and the separation of gases.

Very thin silicone membranes, as would really be needed for optimum membrane performance, are unmanageable, owing to the inadequate mechanical properties. In order to obtain the necessary mechanical stability of the silicones, the membranes described are always composite systems with an in some cases very complicated and expensive, multilayer construction. Here, the separation-selective silicone layer is always applied to a porous support substrate by techniques such as spraying or solution application, for example.

The use of organopolysiloxane copolymers as membranes is also state of the art. US2004/254325 and DE10326575, for example, claim the production and use of thermoplastically processable organopolysiloxane/polyurea copolymers.

In addition, in JP6277438, silicone-polyimide copolymers are also claimed as a material for the production of compact membranes. The applications set out therein are aimed at the separation of gases.

Likewise known in the literature are porous membranes composed of silicone-carbonate copolymers (JP59225703) and also of silicone-polyimide copolymers (JP2008/86903). In the case of both copolymers, however, the mechanical strength and the selectivity are inadequate for industrial use. With both copolymers, moreover, there are virtually no physical interactions present, and this greatly lowers the thermal stability of the porous membrane structure.

Furthermore, the silicone copolymers described are very brittle, making it significantly more difficult to produce typical wound membrane modules.

It is known, furthermore, that with silicone-carbonate copolymers, the carbonate fraction in the copolymer must be high in order to obtain useful film-forming properties. Consequently, the favorable permeabilities of silicone are greatly impaired by the significantly less permeable polycarbonate.

In principle, polymers suitable for the production of porous membranes include only those which possess sufficient mechanical strength and adequate flexibility.

WO2010020584 describes membranes with an asymmetric pore structure made from silicone copolymers which are produced by a phase inversion process and which feature high gas permeability. With membranes made from this material, however, it proves to be a disadvantage that there is an unwanted “cold flow”, as a result of which, under long-term exposure, the porous membranes may suffer changes in their membrane structure.

The object was to provide membranes having an asymmetric pore structure that have the positive properties of the membranes made from silicone copolymers, and that exhibit an increased stability.

The invention provides covalently crosslinked, asymmetrically porous membranes (M) made of thermoplastic silicone elastomers.

The invention also provides a method for producing the covalently crosslinked, a symmetrically porous membranes (M), wherein in a first step, a solution is prepared from silicone composition SZ, which comprises thermoplastic silicone elastomer S1, comprising alkenyl groups, and crosslinker V, and from solvent L,

in a second step, the solution is brought into a form,
in a third step, the solution brought into form is contacted with a precipitation medium F forming a covalently noncrosslinked membrane,
in a fourth step, solvent L and precipitation medium F are removed from the noncrosslinked membrane, and
in a fifth step, the membrane is subjected to crosslinking, producing the covalently crosslinked membrane M.

Thermoplastic elastomers are normally not covalently postcrosslinked, but instead crosslink purely via physical interactions. As shown in examples 3 to 7, the postcrosslinking leads to substantially improved membrane properties in comparison to membranes not covalently crosslinked.

The silicone composition SZ, besides the thermoplastic silicone elastomer S1 comprising alkenyl groups, may comprise further components: catalyst K, silicone compound S2 comprising alkenyl groups, fillers FS and/or additives Z.

Used preferably as thermoplastic silicone elastomer S1 comprising alkenyl groups are silicon copolymers. Examples of such silicone copolymers include the groups of the silicone-carbonate, silicone-imide, silicone-imidazole, silicone-urethane, silicone-amide, silicone-polysulfone, silicone-polyethersulfone, silicone-polyurea, and silicone-polyoxalyldiamine copolymers.

The silicone elastomers S1 are covalently crosslinked in the fifth step with the crosslinker V. If additionally a silicone compound S2 comprising alkenyl groups is used, then it is likewise crosslinked covalently with silicone elastomers S1 by crosslinkers.

Particularly preferred is the use of organopolysiloxane/polyurea/polyurethane/polyamide or polyoxalyldiamine copolymers of the general formula (I)

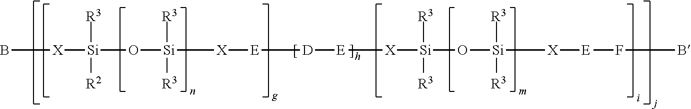

in which the structural element E is selected from the general formulae (Ia-f)

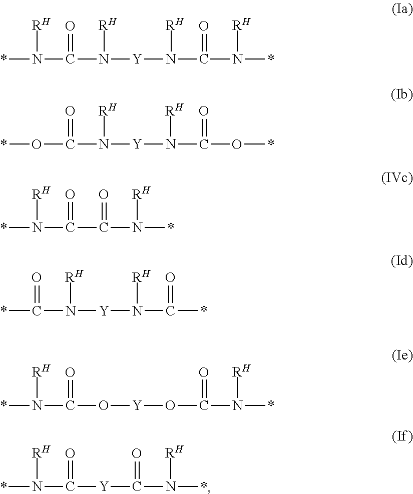

in which the structural element F is selected from the general formulae (IIa-f)

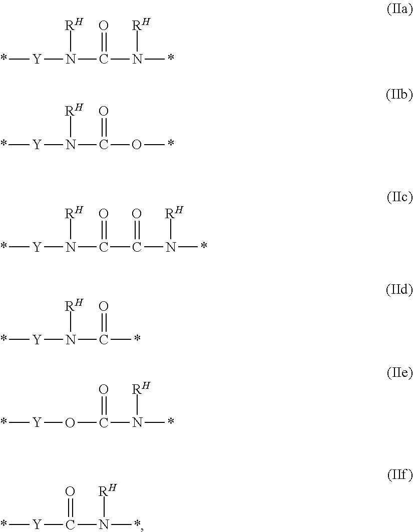

where
R³ denotes substituted or unsubstituted hydrocarbon radicals which may be interrupted by oxygen or nitrogen atoms,
R^{H} is hydrogen or has the definition of R³,
X is an alkylene radical having 1 to 20 carbon atoms, in which methylene units not adjacent to one another may be replaced by —O— groups or is an arylene radical having 6 to 22 carbon atoms,
Y is a divalent hydrocarbon radical optionally substituted by fluorine or chlorine and having 1 to 20 carbon atoms,
D is an alkylene radical which is optionally substituted by fluorine, chlorine, C₁-C₆ alkyl or C₁-C₆ alkyl ester and which has 1 to 700 carbon atoms, in which methylene units not adjacent to one another may be replaced by —O—, —COO—, —OCO—, or —OCOO— groups, or is an arylene radical having 6 to 22 carbon atoms,
B, B′ denote a reactive or nonreactive end group which is bonded covalently to the polymer,
m is an integer from 1 to 4000,
n is an integer from 1 to 4000,
g is an integer which is at least 1,
h is an integer from 0 to 40,
i is an integer from 0 to 30, and
j is an integer greater than 0,
   with the proviso that at least two radicals R³ per molecule comprise at least one alkenyl group.

A radical R³ comprises monovalent or having 1 to 18 carbon atoms, optionally substituted by halogen atoms, amino groups, ether groups, ester groups, epoxy groups, mercapto groups, cyano groups or (poly)glycol radicals, the latter being composed of oxyethylene and/or oxypropylene units, and more preferably comprises alkyl radicals having 1 to 12 carbon atoms, more particularly the methyl radical.

Preferably at least one radical R³ per siloxane unit

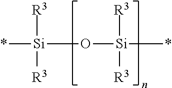

in the organopolysiloxane copolymers of the general formula I comprises an alkenyl group; more preferably 1-5 radicals R³ per siloxane unit

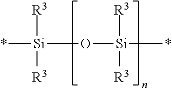

in the organopolysiloxane copolymers of the general formula I comprise an alkenyl group.

Examples of radicals R³ are alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radical; hexyl radicals, such as the n-hexyl radical; heptyl radicals, such as the n-heptyl radical; octyl radicals, such as the n-octyl radical and isooctyl radicals, such as the 2,2,4-trimethylpentyl radical; nonyl radicals, such as the n-nonyl radical; decyl radicals, such as the n-decyl radical; dodecyl radicals, such as the n-dodecyl radical; octadecyl radicals, such as the n-octadecyl radical; cycloalkyl radicals, such as the cyclopentyl, cyclohexyl, cycloheptyl radical and methylcyclohexyl radicals; aryl radicals, such as the phenyl, naphthyl, anthryl, and phenanthryl radical; alkaryl radicals, such as o-, m-, p-tolyl radicals; xylyl radicals and ethylphenyl radicals; and aralkyl radicals, such as the benzyl radical, the α- and the β-phenylethyl radical.

Examples of substituted radicals R³ are methoxyethyl, ethoxyethyl, and the ethoxyethoxyethyl radical or chloropropyl and trifluoropropyl radical.

Examples of divalent radicals R³ are the ethylene radical, polyisobutylenediyl radicals, and propanediyl-terminated polypropylene glycol radicals.

Examples of radicals R³ comprising alkenyl groups are alkenyl radicals having 2 to 12, preferably to 2 to 8 carbon atoms. Preferred are vinyl radical and n-hexenyl radical.

The radical R^{H} preferably comprises hydrogen or the radicals specified above for R³.

Radical Y preferably comprises hydrocarbon radicals having 3 to 13 carbon atoms and being optionally substituted by halogen atoms, such as fluorine or chlorine, and more preferably comprises a hydrocarbon radical having 3 to 13 carbon atoms, more particularly the 1,6-hexamethylene radical, the 1,4-cyclohexylene radical, the methylenebis(4-cyclohexylene) radical, the 3-methylene-3,5,5-trimethylcyclohexylene radical, the phenylene and the naphthylene radical, the m-tetramethylxylylene radical, and the methylenebis(4-phenylene) radical.

Examples of divalent hydrocarbon radicals Y are alkylene radicals, such as the methylene, ethylene, n-propylene, isopropylene, n-butylene, isobutylene, tert-butylene, n-pentylene, isopentylene, neopentylene, tert-pentylene radical, hexylene radicals, such as n-hexylene radical, heptylene radicals, such as the n-heptylene radical, octylene radicals, such as the n-octylene radical and isooctylene radicals, such as the 2,2,4-trimethylpentylene radical, nonylene radicals, such as the n-nonylene radical, decylene radicals, such as the n-decylene radical, dodecylene radicals, such as the n-dodecylene radical; cycloalkylene radicals, such as cyclopentylene, cyclohexylene, cycloheptylene radicals, and methylcyclohexylene radicals, such as the methylenebis(4-cyclohexylene) and the 3-methylene-3,5,5-trimethylcyclohexylene radical; arylene radicals, such as the phenylene and the naphthylene radical; alkarylene radicals, such as o-, m-, p-tolylene radicals, xylylene radicals, such as the m-tetramethylxylylene radical, and ethylphenylene radicals; aralkylene radicals, such as the benzylene radical, the α- and the β-phenylethylene radical, and also the methylenebis(4-phenylene) radical.

Radical X preferably comprises alkylene radicals having 1 to 20 carbon atoms, which may be interrupted by oxygen atoms, and more preferably comprises alkylene radicals having 1 to 10 carbon atoms, which may be interrupted by oxygen atoms, and with more particular preference comprises n-propylene, isobutylene, 2-oxabutylene, and methylene radicals.

Examples of radicals X are the examples specified for radical Y and also optionally substituted alkylene radicals in which the carbon chain may be interrupted by oxygen atoms, such as 2-oxabutylene radical, for example.

Radical B preferably comprises a hydrogen atom, a radical OCN—Y—NH—CO—, a radical H₂N—Y—NH—CO—, a radical R³₃Si—(O—SiR³₂)ₙ—, or a radical R³₃Si—(O—SiR³₂)n—X-E-.

Radical B′ preferably comprises the radicals specified for B.

Radical D preferably comprises divalent polyether radicals and alkylene radicals, more preferably divalent polypropylene glycol radicals, and also alkylene radicals having at least 2 and not more than carbon atoms, such as the ethylene, the 2-methylpentylene, and the butylene radical, and more particularly comprises polypropylene glycol radicals having 2 to 600 carbon atoms, and also the ethylene and the 2-methylpentylene radical.

n preferably denotes a number which is at least 3, more particularly at least 10 and preferably not more than 800, more particularly not more than 400.

m preferably denotes the ranges specified for n.

Preferably g denotes a number which is not more than 100, more preferably from 10 to 60.

Preferably h denotes a number which is not more than 10, more preferably 0 or 1, more particularly 0.

j preferably denotes a number which is not more than 400, more preferably 1 to 100, more particularly 1 to 20.

Preferably i denotes a number which is not more than 10, more preferably 0 or 1, more particularly 0.

For example E=Ia, R^{H}═H, Y=75 mol % m-tetramethylxylylene and 25 mol % methylenebis(4-cyclohexylene), R³═CH₃ and with one H₂C═CH— group per siloxane unit, X=n-propylene, D=2-methylpentylene, B,B′═H₂N—Y—NH—CO—, n=14, g=9, h=1, i=0, j=10.

Crosslinkers V may be, for example, organosilicon compounds having at least two SiH functions per molecule, photoinitiators, photosensitizers, peroxides, or azo compounds.

As crosslinkers V it is possible to use organosilicon compounds comprising at least two SiH functions per molecule. The SiH organosilicon compound preferably possesses a composition of the average general formula (III)

H_{f}R⁵_{g}SiO_{(4-f-g)}/2 (III),

in which
R⁵ is a monovalent, optionally halogen- or cyano-substituted C₁-C₁₈ hydrocarbon radical which is bonded via SiC and which is free from aliphatic carbon-carbon multiple bonds, and
f and g are nonnegative integers,
   with the proviso that 0.5<(f+g)<3.0 and 0<f<2, and that there are at least two silicon-bonded hydrogen atoms per molecule.

Examples of R⁵ are the radicals specified for R². R⁵ preferably has 1 to 6 carbon atoms. Especially preferred are methyl and phenyl.

Preference is given to the use of an SiH organosilicon compound comprising three or more SiH bonds per molecule. Where an SiH organosilicon compound having only two SiH bonds per molecule is used, it is advisable to use a silicone compound S2 which contains alkenyl groups, possessing at least three alkenyl groups per molecule.

The hydrogen content of the SiH organosilicon compound, which relates exclusively to the hydrogen atoms bonded directly to silicon atoms, is preferably in the range from 0.002 to 1.7 wt % hydrogen, preferably from 0.1 to 1.7 wt % hydrogen.

The SiH organosilicon compound preferably comprises at least three and not more than 600 silicon atoms per molecule. Preference is given to using SiH organosilicon compound comprising 4 to 200 silicon atoms per molecule.

The structure of the SiH organosilicon compound may be linear, branched, cyclic, or networklike.

Particularly preferred as SiH organosilicon compound are linear polyorganosiloxanes of the general formula (VI)

(HR⁶₂SiO_{1/2})ₐ(R⁶₃SiO_{1/2})ₜ(R⁶Si_{2/2})ᵤ(R⁶₂SiO_{2/2})ᵥ (VI),

where
R⁶ has the definitions of R⁵, and
the nonnegative integers a, t, u, and v fulfill the following relations: (s+t)=2, (s+u)>2, 5<(u+v)<200, and 1<u/(u+v)<0.1.

For example, R⁶═CH₃, t=2, u=48, v=90, or R⁶═CH₃, t=2, u=9, v=6, or R⁶═CH₃, s=2, v=11.

In the silicone composition SZ, the SiH-functional SiH organosilicon compound is preferably included in an amount such that the molar ratio of SiH groups to alkenyl groups is 0.5 to 5, more particularly 1.0 to 3.0.

As crosslinkers V it is also possible to use photoinitiators and photosensitizers.

Suitable photoinitiators and photosensitizers are in each case optionally substituted acetophenones, propiophenones, benzophenones, anthraquinones, benzyls, carbazoles, xanthones, thioxanthones, fluorenes, fluorenones, benzoins, naphthalenesulfonic acids, benzaldehydes, and cinnamic acids, and also mixtures of photoinitiators or photosensitizers.

Examples thereof are fluorenone, fluorene, carbazole; anisoin; acetophenone; substituted acetophenones, such as 3-methylacetophenone, 2,2′-dimethoxy-2-phenylaceto-phenone, 2,2-diethoxyacetophenone, 4-methylacetophenone, 3-bromoacetophenone, 3′-hydroxyacetophenone, 4′-hydroxyacetophenone, 4-allylacetophenone, 4′-ethoxy-acetophenone, 4′-phenoxyacetophenone, p-diacetyl-benzene, p-tert-butyltrichloroacetophenone; propio-phenone; substituted propiophenones, such as 1-[4-(methylthio)phenyl]-2-morpholine-propanone, 2-hydroxy-2-methylpropiophenone; benzophenone; substituted benzophenones, such as Michler's ketone, 3-methoxy-benzophenone, 3-hydroxybenzophenone, 4-hydroxybenzophenone, 4,4′-dihydroxybenzophenone, 4,4′-dimethylaminobenzophenone, 4-dimethylaminobenzophenone, 2,5-dimethylbenzophenone, 3,4-dimethylbenzophenone, 2-methylbenzophenone, 3-methylbenzophenone, 4-methylbenzophenone, 4-chlorobenzophenone, 4-phenylbenzo-phenone, 4,4′-dimethoxybenzophenone, 4-chloro-4′-benzylbenzophenone, 3,3′,4,4′-benzophenonetetra-carboxylic dianhydride; 2-benzyl-2-(dimethylamino)-4′-morpholinobutyrophenone; camphorquinone; 2-chloro-thioxanthen-9-one; dibenzosuberenone; benzil; substituted benzils, such as 4,4′-dimethylbenzil; phenanthrene; substituted phenanthrenes, such as phenanthrenequinone, xanthone; substituted xanthones, such as 3-chloroxanthone, 3,9-dichloroxanthone, 3-chloro-8-nonylxanthone; thioxanthone; substituted thioxanthones, such as isopropenylthioxanthone, thioxanthen-9-one; anthraquinone; substituted anthraquinones, such as chloroanthraquinone, 2-ethylanthraquinone, anthraquinone-1,5-disulfonic acid disodium salt, anthraquinone-2-sulfonic acid sodium salt; benzoin; substituted benzoins, such as benzoin methyl ether, benzoin ethyl ether, benzoin isobutyl ether; 2-naphthalenesulfonyl chloride; methyl phenylglyoxylate; benzaldehyde; cinnamic acid; (cumene)cyclopentadienyliron(II) hexafluorophosphate; ferrocene. An example of a commercial photoinitiator is Irgacure® 184 from BASF SE.

Peroxides can be used as crosslinkers V as well, especially organic peroxides. Examples of organic peroxides are peroxyketal, e.g., 1,1-bis(tert-butylperoxy)-3,3,5-trimethylcyclohexane, 2,2-bis(tert-butylperoxy)butane; acyl peroxides, such as acetyl peroxide, isobutyl peroxide, benzoyl peroxide, di(4-methylbenzoyl) peroxide, bis(2,4-dichlorobenzoyl) peroxide; dialkyl peroxides, such as di-tert-butyl peroxide, tert-butyl cumyl peroxide, dicumyl peroxide, 2,5-dimethyl-2,5-di(tert-butylperoxy)hexane; and peresters, such as tert-butyl peroxyisopropyl carbonate, for example.

Azo compounds as well can be used as crosslinkers V, such as azobis(isobutyronitrile), for example.

The use of SiH organosilicon compound necessitates the presence of a hydrosilylation catalyst. Hydrosilylation catalysts which can be used are all known catalysts which catalyze the hydrosilylation reactions that proceed in the crosslinking of addition-crosslinking silicone compositions.

Hydrosilylation catalysts used more particularly are metals and their compounds from the group platinum, rhodium, palladium, ruthenium, and iridium.

Platinum and compounds of platinum are used with preference. Particularly preferred platinum compounds are those which are soluble in polyorganosiloxanes. Soluble platinum compounds which can be used include, for example, the platinum-olefin complexes of the formulae (PtCl₂.olefin)₂ and H(PtCl₃.olefin), with preference being given to using alkenes having 2 to 8 carbon atoms, such as ethylene, propylene, isomers of butene and of octene, or cycloalkenes having 5 to 7 carbon atoms, such as cyclopentene, cyclohexene, and cycloheptene. Other soluble platinum catalysts are the platinum-cyclopropane complex of the formula (PtCl₂C₃H₆)₂, the reaction products of hexachloroplatinic acid with alcohols, ethers, and aldehydes and/or mixtures thereof, or the reaction product of hexachloroplatinic acid with methylvinyl-cyclotetrasiloxane in the presence of sodium bicarbonate in ethanolic solution. Particularly preferred are complexes of platinum with vinylsiloxanes, such as sym-divinyltetramethyldisiloxane.

It is also possible to use irradiation-activated hydrosilylation catalysts, as described in WO2009/092762, for example.

The hydrosilylation catalyst may be used in any desired form, including, for example, in the form of microcapsules comprising hydrosilylation catalyst, or polyorganosiloxane particles.

The amount of hydrosilylation catalysts is preferably selected such that the silicone composition SZ possesses a Pt content of 0.1 to 250 weight-ppm, more particularly of 0.5 to 180 weight-ppm.

When hydrosilylation catalysts are present, the use of inhibitors is preferred. Examples of customary inhibitors are acetylenic alcohols, such as 1-ethynyl-1-cyclohexanol, 2-methyl-3-butyn-2-ol, and 3,5-dimethyl-1-hexine-3-ol, 3-methyl-1-dodecine-3-ol, polymethylvinylcyclosiloxanes, such as, for example, 1,3,5,7-tetravinyltetramethyltetracyclosiloxane, low molecular mass silicone oils comprising (CH₃) (CHR═CH)SiO_{2/2} groups and optionally R₂(CHR═CH)SiO_{1/2} end groups, such as divinyltetramethyldisiloxane, tetravinyldimethyldisiloxane, trialkyl cyanurates, alkyl maleates, such as diallyl maleates, dimethyl maleate, and diethyl maleate, for example, alkyl fumarates, such as diallyl fumarate and diethyl fumarate, for example, organic hydroperoxides, such as cumene hydroperoxide, tert-butyl hydroperoxide, and pinane hydroperoxide, for example, organic peroxides, organic sulfoxides, organic amines, diamines, and amides, phosphanes and phosphites, nitriles, triazoles, diaziridines, and oximes. The effect of these inhibitors is dependent on their chemical structure, and so the appropriate inhibitor and the amount in the silicone composition SZ must be determined on an individual basis. The amount of inhibitors in the silicone composition SZ is preferably 0 to 50 000 weight-ppm, more preferably 20 to 2000 weight-ppm, more particularly 100 to 1000 weight-ppm.

When using photoinitiators, peroxides, or azo compounds as crosslinkers V, there is no need for catalyst and inhibitor.

Where photoinitiators and/or photosensitizers are used for crosslinking, they are employed in amounts of 0.1-10 wt %, preferably 0.5-5 wt %, and more preferably 1-4 wt %, based on the silicone elastomer S1.

Where azo compounds or peroxides are used for crosslinking, they are employed in amounts of 0.1-10 wt %, preferably 0.5-5 wt %, and more preferably 1-4 wt %, based on the silicone elastomer S1.

The silicone compound S2 containing alkenyl groups preferably possesses a composition of the average general formula (V)

R¹ₐR²_{b}SiO_{(4-a-b)}/2 (V),

in which
R¹ is a monovalent, optionally halogen- or cyano-substituted C₁-C₁₀ hydrocarbon radical which is optionally bonded via an organic divalent group to silicon and which comprises aliphatic carbon-carbon multiple bonds,
R² is a monovalent, optionally halogen- or cyano-substituted C₁-C₁₀ hydrocarbon radical which is bonded via SiC and which is free from aliphatic carbon-carbon multiple bonds,
a is a nonnegative number such that at least two radicals R¹ are present in each molecule, and
b is a nonnegative number, so that (a+b) is in the range from 0.01 to 2.5.

The alkenyl groups R¹ are amenable to an addition reaction with an SiH-functional crosslinker V. Used typically are alkenyl groups having 2 to 6 carbon atoms, such as vinyl, allyl, methallyl, 1-propenyl, 5-hexenyl, ethynyl, butadienyl, hexadienyl, cyclopentenyl, cyclopentadienyl, cyclohexenyl, preferably vinyl and allyl.

Organic divalent groups via which the alkenyl groups R¹ may be bonded to silicon in the polymer chain consist, for example, of oxyalkylene units, such as those of the general formula (VI)

—(O)_{c}[(CH₂)_{d}O]ₑ— (VX),

in which
c denotes the values 0 or 1, more particularly 0,
d denotes values of 1 to 4, more particularly 1 or 2, and
e denotes values of 1 to 20, more particular of 1 to 5.

The oxyalkylene units of the general formula (VI) are bonded at the left to a silicon atom.

The radicals R¹ may be bonded in any position of the polymer chain, more particularly to the terminal silicon atoms.

Examples of unsubstituted radicals R² are alkyl radicals, such as the methyl, ethyl, n-propyl, isopropyl, n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical; alkenyl radicals, such as the vinyl, allyl, n-5-hexenyl, 4-vinylcyclohexyl, and the 3-norborneneyl radical; cycloalkyl radicals, such as cyclopentyl, cyclohexyl, 4-ethylcyclohexyl, cycloheptyl radicals, norbornyl radicals, and methylcyclohexyl radicals; aryl radicals, such as the phenyl, biphenylyl, naphthyl radical; alkaryl radicals, such as o-, m-, p-tolyl radicals and ethylphenyl radicals; aralkyl radicals, such as the benzyl radical, the alpha- and the β-phenylethyl radical.

Examples of substituted hydrocarbon radicals as radicals R² are halogenated hydrocarbons, such as the chloromethyl, 3-chloropropyl, 3-bromopropyl, 3,3,3-trifluoropropyl, and 5,5,5,4,4,3,3-heptafluoropentyl radical, and also the chlorophenyl, dichlorophenyl, and trifluorotolyl radical.

R² preferably has 1 to 6 carbon atoms. Especially preferred are methyl and phenyl.

Silicone compound S2 may also be a mixture of different polyorganosiloxanes comprising alkenyl groups, these compounds differing, for example, in the alkenyl group content, in the nature of the alkenyl group, or structurally.

The structure of the silicone compound S2 may be linear, cyclic, or else branched. The amount of tri- and/or tetrafunctional units leading to branched polyorganosiloxanes is typically very low, preferably not more than 20 mol %, more particularly not more than 0.1 mol %.

Silicone compound S2 may be a silicone resin. In that case (a+b) is preferably in the range from 2.1 to 2.5, more particularly from 2.2 to 2.4.

With particular preference, silicone compound S2 comprises organopolysiloxane resins S2 which consist to an extent of at least 90 mol % of R⁴₃SiO_{1/2} (M) and SiO_{4/2} (Q) units, with R⁴ having the definitions of R¹ or R², where at least two, more particularly at least three, of radicals R⁴ per molecule are R¹. These resins are also referred to as MQ resins. The molar ratio of M to Q units is preferably in the range from 0.5 to 2.0, more preferably in the range from 0.6 to 1.0. These silicone resins may further comprise up to 10 wt % of free hydroxyl or alkoxy groups.

These organopolysiloxane resins S2 preferably have, at 25° C., a viscosity of more than 1000 mPas or are solids. The weight-average molecular weight of these resins, determined by gel permeation chromatography (and based on a polystyrene standard) is preferably at least 200, more preferably at least 1000 g/mol, and preferably not more than 200 000, more preferably not more than 20 000 g/mol.

Silicone compound S2 may be a silica whose surface is occupied by alkenyl groups R¹. In that case (a+b) is preferably in the range from 0.01 to 0.3, more particularly from 0.05 to 0.2. The silica is preferably precipitated silica, more particularly fumed silica. The silica preferably has an average primary-particle particle size of less than 100 nm, more particularly an average primary-particle size of 5 to 50 nm, these primary particles usually not existing in isolated form in the silica, but instead being components of larger aggregates (definition as per DIN 53206) having a diameter of 100 to 1000 nm.

The silica further has a specific surface area of 10 to 400 m²/g (measured by the BET method in accordance with DIN 66131 and 66132), with the silica having a mass fractal dimension Dₘ of less than or equal to 2.8, preferably less than or equal to 2.7, more preferably of 2.4 to 2.6, and a density of surface silanol groups SiOH of less than 1.5 SiOH/nm², preferably of less than 0.5 SiOH/nm², more preferably of less than 0.25 SiOH/nm².

The silica preferably has a carbon content, as a result more particularly of the surface occupancy by alkenyl groups R¹, of 0.1 to 10 wt %, more particularly 0.3 to 5 wt %.

Particularly preferred as silicone compound S2 are polydimethylsiloxanes which comprise vinyl groups and whose molecules conform to the general formula (V)

(ViMe₂SiO_{1/2})₂(ViMeSiO)ₚ(Me₂SiO)_{q} (V),

in which the nonnegative integers p and q fulfill the following relations: p≧0, 50<(p+q)<20 000, preferably 100<(p+q)<1000, and 0<(p+1)/(p+q)<0.2. More particularly p is 0. The viscosity of the silicone compound S2 of the general formula (V) at 25° C. is preferably 0.5 to 500 Pa's, more particularly 1 to 100 Pa's, very preferably 1 to 50 Pa's.

For example q=120 and p=0 or q=150 and p=0.

Where the silicone composition SZ comprises an alkenyl-containing silicone compound S2, the fraction of S2 is 0.5-40 wt %, more preferably 2-30 wt %, based on the silicone composition SZ.

The silicone composition SZ may comprise at least one filler FS. Nonreinforcing fillers FS having a BET surface area of up to 50 m²/g are, for example, quartz, diatomaceous earth, calcium silicate, zirconium silicate, zeolites, metal oxide powders, such as aluminum, titanium, iron, or zinc oxides and/or mixed oxides thereof, barium sulfate, calcium carbonate, gypsum, silicon nitride, silicon carbide, boron nitride, glass powders, and plastics powders. A listing of further fillers in particle form is found in EP 1940940. Reinforcing fillers, i.e., fillers having a BET surface area of at least 50 m²/g, more particularly 100 to 400 m²/g, are, for example, pyrogenically produced silica, precipitated silica, aluminum hydroxide, carbon black, such as furnace black and acetylene black, and mixed silicon aluminum oxides of high BET surface area.

The stated fillers FS may have been hydrophobized, by treatment with organosilanes, organosilazanes and/or organosiloxanes, for example, or by etherification of hydroxyl groups to alkoxy groups. It is possible to use one kind of filler FS; it is also possible to use a mixture of at least two fillers FS.

The silicone compositions SZ preferably comprise at least 3 wt %, more preferably at least 5 wt %, more particularly at least 10 wt %, and not more than 40 wt % of filler fraction FS.

The silicone composition SZ may alternatively comprise, as further constituent Z, possible adjuvants, at a fraction of 0 to 70 wt %, preferably 0.0001 to 40 wt %. These adjuvants may be, for example, resinous polyorganosiloxanes, different from the SiH organosilicon compound and silicone compound S2 containing alkenyl groups; adhesion promoters, pigments, dyes, plasticizers, organic polymers, heat stabilizers, inhibitors, fungicides or bactericides, such as methylisothiazolones or benzisothiazolones, crosslinking assistants, such as triallyl isocyanurate, flow control assistants, surface-active substances, adhesion promoters, light stabilizers such as UV absorbers and/or radical scavengers, thixotropic agents.

The thermoplastic silicone elastomers S1 are suitable for the simple and cost-effective production of asymmetrically constructed membranes (M) by means of the phase inversion process. The effect of the urea groups of the thermoplastic silicone elastomers S1 is a physical crosslinking of the membranes (M) via hydrogen bonds after the phase inversion, and consequently they fix the asymmetric structure. The physical crosslinking, however, is insufficient to achieve high stability and load-bearing capacity.

A high mechanical stability on the part of the membranes (M), relative to the pressure of the composition that is to be separated, among other things, is nevertheless vital for technical use of the membranes (M). The mechanical stability is improved substantially by the covalent crosslinking of the membranes. When using membranes in reverse osmosis, ultra-, nano-, and microfiltration, and also gas separation and pervaporation installations, in particular, membranes are needed which are able to withstand very high mechanical loads.

The flexibility is retained in spite of the covalent crosslinking. The possible collapse of the porous structures after the phase inversion process, even at relatively high temperatures, is not observed. The amide moieties of the thermoplastic silicone elastomers S1 influence the diffusion and solubility of the molecules for separation, this influence leading in the majority of cases to an improvement in the selectivity of the membranes (M) relative to pure silicones.

Relative to membranes of the prior art, the membranes (M) have a much higher flow rate and a markedly improved stability.

Although the selectivities of the silicones known in the literature appear in certain cases to be sufficient for the separation of gas mixtures, the attainable gas flows through these membranes are too low, thereby greatly adversely affecting their overall performance and therefore greatly hindering their technical deployment.

Moreover, the pore structure of the membranes (M) can be varied easily within a wide range. In this way it is also possible to realize membrane applications, such as microfiltration or else H₂O vapor/H₂O liquid separation, for example, which were not achievable with the silicone copolymer membranes produced before now.

It is likewise possible, in comparison to the majority of commercial membranes, to separate hydrophobic media easily as well.

All in all, therefore, relative to pure silicone membranes or other silicone copolymer membranes, the crosslinked, porous membranes (M) exhibit a markedly improved profile of properties in terms of very important membrane properties.

Another feature of the membranes (M) is that they exhibit excellent storage stability. This means that after a storage time of 4 months, the membranes (M) show no significant changes in separation performance.

A characteristic of membranes produced by the phase inversion process, also referred to as the Loeb-Sourirajan process, is their asymmetric construction, with a thin, separation-selective layer and a porous undercarriage which ensures the mechanical stability. Membranes of this kind are particularly preferred.

In the first step of producing the membranes (M), the silicone composition SZ is dissolved in an organic or inorganic solvent L or mixtures thereof.

Preferred organic solvents L are hydrocarbons, halogenated hydrocarbons, ethers, alcohols, aldehydes, ketones, acids, anhydrides, esters, N-containing solvents, and S-containing solvents.

Examples of typical hydrocarbons are pentane, hexane, dimethylbutane, heptane, hex-1-ene, hexa-1,5-diene, cyclohexane, turpentine, benzene, isopropylbenzene, xylene, toluene, naphthalene, and also tetrahydronaphthalene. Examples of typical halogenated hydrocarbons are fluoroform, perfluoroheptane, methylene chloride, chloroform, carbon tetrachloride, 1,2-dichloroethane, 1,1,1-trichloroethane, pentyl chloride, bromoform, 1,2-dibromothane, methylene iodide, fluorobenzene, chlorobenzene, and 1,2-dichlorobenzene. Examples of typical ethers are diethyl ether, butyl ethyl ether, anisole, diphenyl ether, ethylene oxide, tetrahydrofuran, furan, and 1,4-dioxane. Examples of typical alcohols are methanol, ethanol, propanol, butanol, octanol, cyclohexanol, benzyl alcohol, ethylene glycol, ethylene glycol monomethyl ether, propylene glycol, butyl glycol, glycerol, phenol, and m-cresol. Examples of typical aldehydes are acetaldehyde and butyraldehyde. Examples of typical ketones are acetone, diisobutyl ketone, butan-2-one, cyclohexanone, and acetophenone. Typical examples of acids are formic acid and acetic acid. Typical examples of anhydrides are acetic anhydride and maleic anhydride. Typical examples of esters are methyl acetate, ethyl acetate, butyl acetate, phenyl acetate, glycerol triacetate, diethyl oxalate, dioctyl sebacate, methyl benzoate, dibutyl phthalate, and also tricresyl phosphate. Typical examples of nitrogen-containing solvents are nitromethane, nitrobenzene, butyronitrile, acetonitrile, benzonitrile, malononitrile, hexylamine, aminoethanol, N,N-diethylaminoethanol, aniline, pyridine, N,N-dimethylaniline, N,N-dimethylformamide, N-methylpiperazine, N-methyl-2-pyrrolidone, N-ethyl-2-pyrrolidone, and 3-hydroxypropionitrile. Typical examples of sulfur-containing solvents L are carbon disulfide, methanethiol, dimethyl sulfone, dimethyl sulfoxide, and thiophene.

Typical examples of inorganic solvents are water, ammonia, hydrazine, sulfur dioxide, silicon tetrachloride, and titanium tetrachloride.

In one preferred embodiment of the invention, the silicone composition SZ is dissolved in solvent mixtures L. Typical examples of binary solvent mixtures L are isopropanol/N-methylpiperazine, isopropanol/aminoethanol, isopropanol/N,N-diethylaminoethanol, isopropanol/dimethylformamide, isopropanol/-tetrahydrofuran, isopropanol/N-methyl-2-pyrrolidone, isopropanol/N-ethyl-2-pyrrolidone, and isopropanol/-dimethyl sulfoxide. Preferred here are mixing ratios of 5:1 to 1:5, more preferably the range from 4:1 to 1:4, and very preferably the range 3:1 to 1:3.

In a further preferred embodiment of the invention, silicone composition SZ is dissolved in tertiary solvent mixtures L. Typical examples of tertiary solvent mixtures are isopropanol/N-methyl-piperazine/aminoethanol, isopropanol/N-methyl-piperazine/dimethylformamide, isopropanol/N-methylpiperazine/tetrahydrofuran, isopropanol/N-methylpiperazine/dimethyl sulfoxide, isopropanol/aminoethanol/dimethylformamide, isopropanol/N-methylpiperazine/N,N-diethylaminoethanol, isopropanol/dimethylformamide/N,N-diethylaminoethanol, isopropanol/aminoethanol/tetrahydrofuran, isopropanol/aminoethanol/dimethyl sulfoxide, and isopropanol/dimethylformamide/dimethyl sulfoxide.

Preferred mixing ratios here are 3:1:1, 2:1:1, 1:1:1, 1:2:2, and 1:2:3.

Preferred solvents L for the silicone composition SZ dissolve in the precipitation medium F. Suitable solvent duos L are water/isopropanol, water/-tetrahydrofuran, water/dimethylformamide, water/N-methylpiperazine, water/dimethyl sulfoxide, water/-aminoethanol, water/N,N-diethylaminoethanol, THF/-dimethylformamide, isopropanol/dimethylformamide, THF/-N-methyl-2-pyrrolidone, isopropanol/N-methyl-2-pyrrolidone, and also the binary and tertiary solvent mixtures L described.

In one embodiment of the invention the thermoplastic silicone elastomer S1 is introduced initially, then the solvent or solvent mixture L is added, and subsequently the further components of the silicone composition SZ are added.

In one preferred embodiment of the invention, the solvent or solvent mixture L is introduced initially and thereafter the individual constituents of the silicone composition SZ are added.

In one particularly preferred embodiment, the thermoplastic silicone elastomer S1 is introduced initially, mixed with N-methyl-2-pyrrolidone, and then fully dissolved with isopropanol, and subsequently the further components of the silicone composition SZ are added.

The concentration of silicone elastomer S1 is in a range from 5 to 60 wt %, based on the weight of the solution of the silicone composition SZ. In one preferred embodiment of the invention, the concentration of silicone elastomer S1 is 10 to 40 wt %. In one particularly preferred embodiment of the invention, the concentration of silicone elastomer S1 is in a range from 12 to 33 wt %.

The solutions of the silicone composition SZ are prepared by usual techniques, such as stirring, shaking, or mixing, for example, more preferably by shaking in the solvent L or solvent mixture L.

In some cases the dissolution process can be accelerated considerably by heating of the solutions.

Temperatures of 10 to 160° C. are preferred. Further preferred is the temperature range from 22 to 40° C. Particular preference is given to producing the solution of silicone composition SZ at room temperature.

The solutions are mixed until there is a homogeneous solution in which all of the components of the silicone compositions SZ are fully dissolved. The time for this dissolution procedure amounts, for example, to between min and 48 h. In one preferred embodiment of the invention, the dissolution process lasts between 1 h and 24 h, more preferably between 2 h and 8 h.

In one embodiment of the invention, further additions Z are added to the silicone composition SZ. Typical additions Z are inorganic salts and polymers that are soluble in the precipitation medium F. Typical inorganic salts are LiF, NaF, KF, LiCl, NaCl, KCl, MgCl₂, CaCl₂, ZnCl₂, and CdCl₂. In one preferred embodiment of the invention, additives Z added to the polymer solution are water-soluble polymers. Typical water-soluble polymers are poly(ethylene glycols), poly(propylene glycols), poly(propylene ethylene glycols), poly(vinylpyrrolidones), poly(vinyl alcohols), silicone-alkylene oxide copolymers, and sulfonated polystyrenes. A large part of the additions Z dissolve in the precipitation medium F on phase inversion and are no longer present in the membrane (M). Residues of the additions Z which remain in the membrane (M) still after the production process may make the membrane (M) more hydrophilic overall.

Mixtures of different additions Z can also be incorporated here into the solution of the silicone composition SZ. Accordingly, in one particularly preferred embodiment of the invention, 2 wt % of LiCl and 3 wt % of poly(vinylpyrrolidone) are added to the polymer solution. The additions Z make the membrane (M) much more porous by the phase inversion process. The concentration of the additions the Z in the solution of the silicone composition SZ is between 0.01 wt % and up to 50 wt %. In one preferred embodiment of the invention, the concentration is 0.1 wt % to 15 wt %. In one particularly preferred embodiment of the invention, the concentration of the additions Z is 1 to 5 wt %.

In the second step, the above-described solution of the silicone composition SZ is brought into a form, preferably a film or a fiber. For this purpose the solutions of the silicone composition SZ are preferably applied to a substrate or spun. The solutions applied to substrates are processed onward to flat membranes, while the spun solutions are processed to hollow fiber membranes.

In one preferred embodiment of the invention, the solutions of the silicone composition SZ are applied to a substrate by means of doctor blade application.

It has emerged as being particularly advantageous to filter the solution with conventional filter cartridges prior to doctor blade application. This filtration step removes large particles which can lead to defects at the membrane production stage. The pore size of these filters is preferably 0.2 μm to 100 μm. Preferred pore sizes are situated at 0.2 μm to 50 μm. Particularly preferred pore sizes are 0.2 to 10 μm.

It has also emerged as being particularly advantageous to degas the solutions of the silicone composition SZ ahead of doctor blade application.

The height of the polymer film in this case is influenced substantially by the slot height of the doctor blade used. The slot height of the doctor blade is preferably at least 1 μm, more preferably at least 20 μm, more particularly at least 50 μm, and preferably not more than 2000 μm, more preferably not more than 500 μm, more particularly not more than 300 μm. In order to avoid the polymer film running after doctor blade application, the doctor blade height set ought not to be too high.

There is in principle no limit on the width of doctor blade application. Typical widths are in the range from 5 cm to 2 m. In one preferred embodiment of the invention, the doctor blade width is at least 10 cm and not more than 1 m, more particularly not more than 50 cm.

Another possibility for producing the wet polymer film is the meniscus coating of an appropriate substrate with the solutions of the silicone composition SZ. Other possibilities for producing the polymer films include all customary methods, examples being casting, spraying, screen printing, gravure printing, and spin-on-disk.

The film thickness is adjusted through the viscosity of the solution and through the film-forming rate.

The rate of application must in principle be selected such that the solution is still able to wet the substrate, so that no flow defects occur during film production. Typical rates in this context are preferably at least 1 cm/s, more preferably at least 1.5 cm/s, more particularly at least 2.5 cm/s, and preferably not more than 1 m/s, more preferably not more than 0.5 m/s, more particularly not more than 10 cm/s.

In one preferred embodiment of the invention, application takes place at temperatures above 20° C. In one particularly preferred embodiment of the invention, application takes place in a temperature range from 25 to 50° C.

There are in principle a number of possibilities for adjusting the temperature. Not only the solutions produced but also the substrates used may be brought to the temperature. In certain cases it may be advantageous to heat both the solutions of the silicone composition SZ and the substrate as well to the desired temperature.

In one preferred embodiment of the invention, the solution is conditioned at 40° C. to 60° C. and applied to the substrate, which is conditioned at 20° C. to 25° C.

Suitable substrates for the polymer films described are in principle all planar surfaces. Particularly suitable as substrate material are metals, polymers, woven fabrics, polymer-coated woven fabrics, and glasses. Suitable metals here consist of titanium, iron, copper, aluminum, and the alloys thereof.

Any polymers that can be processed into films or nonwovens can be used as substrates. Examples of such polymers are cellulose, polyamides, polyimides, polyetherimides, polycarbonates, polybenzimidazoles, polyethersulfones, polyesters, polysulfones, polytetrafluoroethylenes, polyurethanes, polyvinyl chlorides, polyether glycols, polyethylene terephthalate (PET), polyaryl ether ketones, polyacrylonitrile, polymethyl methacrylates, polyphenylene oxides, polycarbonates, polyethylenes, polypropylenes, and their possible copolymers. Glass substrates which can be used are all typical glasses. Examples are quartz glass, lead glass, float glass, or soda-lime glass, for example.

The materials described may be present in the form of plates, films, nets, woven and non-woven, and also as nonwoven webs.

In the case of the production of the membranes on woven or non-woven nets, and also on nonwoven fabrics, the spacer is already joined to the membrane.

In one preferred embodiment of the invention, the film is applied to a PET film having a layer thickness of 100 μm to 50 μm. In a likewise preferred embodiment of the invention, the film is produced on a glass plate having a layer thickness of 0.5 to 1.5 mm. In a further preferred embodiment, the film is produced on a PTFE-coated woven fabric.

In one particularly preferred embodiment of the invention, the film is applied to nonwoven fabrics, resulting in a membrane/nonwoven fabric composite material after the precipitation procedure, resulting in time savings and low manufacturing costs in the subsequent manufacture of the membrane modules. The preferred production of the porous membranes on the nonwoven fabrics breaks down into the application of the still-wet polymer film to the nonwoven, with subsequent phase inversion with the precipitation medium F in the third step.

Particularly preferred nonwoven fabrics are those which have no defects, such as holes or vertical fibers, for example, on the surface.

The porous membrane here may be applied both to non-woven and woven web fabrics.

In one preferred embodiment of the invention, the porous membrane is applied to a non-woven web. Preferred materials for the nonwoven fabrics used are cellulose, polyesters, polyethylenes, polypropylenes, polyethylene/polypropylene copolymers, or polyethylene terephthalates.

In one particularly preferred embodiment of the invention, the porous membrane (M) is applied to a non-woven polyester web.

In a further preferred embodiment of the invention, the porous membrane (M) is applied to a glass fiber nonwoven, carbon fiber nonwoven, or aramid fiber nonwoven.

The layer thickness of the substrates for the porous membrane (M) is guided by the technical circumstances of the coating unit, and is preferably at least 10 μm, more preferably at least 50 μm, more particularly at least 100 μm, and preferably not more than 2 mm, more preferably not more than 600 μm, more particularly not more than 400 μm.

The substrates used for the production of the membranes may have been surface-treated with additional substances. These substances might include flow control assistants, surface-active substances, adhesion promoters, light stabilizers such as UV absorbers and/or radical scavengers. In one preferred embodiment of the invention, the films are additionally treated with ozone or UV light. Additions of these kinds are preferred in order to generate the particular desired profiles of properties of the membranes.

In a further preferred embodiment of the invention, the silicone composition SZ is processed in the second step by spinning to form hollow fibers.

The external diameter of the fiber is preferably at least 10 μm, more preferably at least 100 μm, more particularly at least 200 μm, better still at least 300 μm, and preferably not more than 5 mm, more preferably not more than 2 mm, more particularly not more than 1000 μm.

The maximum internal diameter of the hollow fiber is limited by the maximum external diameter, and is preferably at least 8 μm, more preferably at least 80 μm, more particularly at least 180 μm, better still at least 280 μm, and preferably not more than 4.5 mm, more preferably not more than 1.9 mm, more particularly not more than 900 μm.

In order to prevent the collapse of the internal channels during the hollow fiber manufacturing process, a further medium can be injected into this channel. The medium comprises either gases or liquids.

Examples of typical gaseous media are air, compressed air, nitrogen, oxygen, or carbon dioxide.

Examples of typical liquid media are water or organic solvents. Preferred organic solvents are hydrocarbons, halogenated hydrocarbons, ethers, alcohols, aldehydes, ketones, acids, anhydrides, esters, N-containing solvents, and S-containing solvents.

Through the appropriate selection of the precipitation medium F and of the medium applied in the interior of the hollow fiber, the phase inversion may take place only from the outside, only from the inside, or from both sides simultaneously. Accordingly, in the hollow fiber membrane, the separation-selective layer may be formed on the outside, inside, or in the hollow fiber wall.

In one preferred embodiment of the invention, water is used as precipitation medium F, and toluene is injected in the interior of the hollow fiber.

A further possibility for preventing the collapse of the hollow fibers is to use flexible tubes of nonwoven web. In that case, as in the case of the substrate-bound membranes, the polymer solution is applied to the inside or to the outside of the flexible tube.

In the production of the hollow fibers it is likewise possible to co-spin a second polymer ply.

Particular preference is given to spinning at elevated temperatures. In this way it is possible to increase the speed for the production of the hollow fibers.

Typical temperatures here are above 20° C. Particular preference is given to spinning at temperatures of 20° C. to 150° C. In one particularly preferred embodiment of the invention, the hollow fibers are produced at 25 to 55° C.

For the production of the membranes (M), the films or hollow fibers can be subjected to preliminary drying for a defined time before being immersed into the precipitation bath.

The preliminary drying may take place under ambient conditions. In certain cases it may be advantageous to carry out the preliminary drying under defined ambient conditions, i.e., temperature and relative humidity. The temperature in this context is preferably at least 0° C., more preferably at least 10° C., more particularly at least 25° C., and preferably not more than 150° C., more preferably not more than 75° C.

In the case of preliminary drying it is necessary to ensure that the crosslinking process does not yet commence.

The length of the preliminary drying time is dependent on the ambient conditions. Typically, the preliminary drying time is longer than 5 seconds.

In one preferred embodiment of the invention, the preliminary drying time is 7 seconds to 10 minutes.

In one particularly preferred embodiment of the invention, the preliminary drying time is 10 to 30 seconds.

In a likewise preferred embodiment of the invention, the preliminary drying time is 30 seconds to 1 minute.

In the third step, the solutions brought into form, more particularly the polymer films or hollow fibers, are contacted with a precipitation medium F, being more particularly immersed into a precipitation bath filled with precipitation medium F. The third step represents a phase inversion process.

The precipitation medium F is a liquid in which the silicone composition SZ has a solubility at 20° C. of preferably no more than 2 wt %. In one preferred embodiment of the invention, the solvent L or solvent mixture L which is used for producing the solution in the first step dissolves to an extent of at least 10 wt %, more particularly at least 30 wt %, in the precipitation medium F at the temperature and pressure prevailing in the third step.

The most common precipitation medium F is water, more particularly deionized water. Water is also the preferred precipitation medium F for the production of the membranes (M). Other preferred precipitation media F are alcohols, such as methanol, ethanol, isopropanol, and longer-chain alcohols, or N-containing solvents, such as acetonitrile, for example. In addition, however, the solvents and solvent mixtures described for the production of the polymer solution are also suitable in principle as precipitation medium F. It must always be ensured here, however, that the silicone composition SZ does not dissolve completely in the precipitation medium F.

The temperature of the precipitation medium F may greatly influence the structure of the membrane (M). The temperature of the precipitation medium F for the production of the noncrosslinked membranes (M) lies between the melting temperature and the boiling temperature of the precipitation medium F that is used. The temperature is situated preferably in a range from 0° C. to 80° C. More preferably the temperature is situated in a range from 10° C. to 60° C.

Besides, the precipitation medium F may also comprise additives which influence the precipitation of the silicone composition SZ in the precipitation bath. Typical additives of the precipitation medium F in this context are inorganic salts, and polymers that are soluble in the precipitation medium F. Typical inorganic salts are LiF, NaF, KF, LiCl, NaCl, KCl, MgCl₂, CaCl₂, ZnCl₂, and CdCl₂. In one preferred embodiment of the invention, water-soluble polymers are added to the precipitation medium F. Typical water-soluble polymers are poly(ethylene glycols), poly(propylene glycols), poly(propylene-ethylene glycols), poly(vinylpyrrolidones), poly(vinyl alcohols), silicone-alkylene oxide copolymers, and sulfonated polystyrenes.

The precipitation medium F may, moreover, comprise the additions and additives that are customary in solutions. Examples include flow control assistants, surface-active substances, adhesion promoters, light stabilizers such as UV absorbers and/or radical scavengers.

The major fraction of the additives is no longer present in the membrane after its production. Additives which remain in the membrane (M) after production may make the membrane (M) more hydrophilic.

Mixtures of different additives may also be incorporated into the precipitation medium F. Thus, in one particularly preferred embodiment of the invention, 0.3 to 0.8 wt % of dodecyl sulfate and 0.3 to 0.8 wt % of LiF are added to the precipitation bath.

The concentration of the additives in the precipitation medium F is preferably at least 0.01 wt %, more preferably at least 0.1 wt %, more particularly at least 1 wt %, and preferably not more than 30 wt %, more preferably not more than 15 wt %, more particularly not more than 5 wt %.

Such additions are preferred in order to generate the particular desired profiles of properties of the membranes (M).

The rate at which the solution brought into form, more particularly the polymer film or the hollow fiber, is immersed into the precipitation medium F must in principle be selected such that the solvent exchange that is necessary for membrane production can take place. Typical immersion rates are preferably at least 1 cm/s, more preferably at least 2 cm/s, more particularly at least 5 cm/s, better still at least 10 cm/s, and preferably not more than 1 m/s, more preferably not more than 50 cm/s, more particularly not more than 30 cm/s.

The rate is preferably set such that the noncrosslinked membranes (M) are produced continuously. In a method of this kind, the generation of the wet solution brought into form takes place preferably at the same rate as the immersion into the inversion bath. The time between the production of the solution brought into form and its immersion into the precipitation medium F is set such that the solution brought into form passes through the time that may be necessary for preliminary drying.

The angle at which the solution brought into form is immersed into the precipitation medium F must in principle be selected such that solvent exchange is not blocked. Typical angles are preferably at least 1°, more preferably at least 10°, more particularly at least 15°, and preferably not more than 90°, more preferably not more than 70°, more particularly not more than 45°. Hollow fibers are immersed into the precipitation medium F preferably at an angle of 85° to 90°.

The hollow fibers may be produced with or without an air gap between nozzle and precipitation bath.

The length of time for which the solution brought into form is held in the precipitation medium F must in principle be selected such that there is sufficient time until solvent exchange has taken place. Typical times in this context are preferably at least 10 s, more preferably at least 30 s, more particularly at least 1 min, and preferably not more than 20 h, more preferably not more than 60 min, more particularly not more than 30 min.

In the fourth step, residues of solvent L and/or precipitation medium F are removed from the noncrosslinked membrane, this being accomplished preferably by evaporation. In the fifth step, the noncrosslinked membrane consisting of silicone composition SZ is subjected to crosslinking. The temporal sequence here is arbitrary; the two steps may be carried out in succession or simultaneously.

Preferably, the removal of residues of solvent L or precipitation medium F takes place first, in the fourth step, followed by the crosslinking of the silicone composition SZ, in the fifth step.

Where SiH organosilicon compounds are used for the crosslinking of the silicone composition SZ, and a hydrosilylation catalyst is employed, the crosslinking is preferably accomplished thermally, preferably at 30 to 250° C., more preferably at not less than 50° C., more particularly at not less than 100° C., preferably at 120-210° C. Where UV-switchable hydrosilylation catalysts are used, the crosslinking takes place by irradiation with light of wavelength 230-400 nm for preferably at least 1 second, more preferably at least 5 seconds, and preferably not more than 500 seconds, more preferably not more than 240 seconds.

Where the crosslinking of the silicone composition SZ is accomplished using photoinitiators, the irradiation of the silicone composition SZ with light takes preferably at least 1 second, more preferably at least seconds, and preferably not more than 500 seconds, more preferably not more than 240 seconds. Crosslinking with photoinitiators may take place under inert gas such as N₂ or Ar, for example, or under air.

The irradiated silicone composition SZ, following irradiation with light, is heated for preferably not more than 1 hour, more preferably not more than 10 minutes, more particularly not more than 1 minute, in order to cure it. The crosslinking of the noncrosslinked membrane under UV radiation takes place, with particular preference, at 254 nm.

Where peroxides are used for the crosslinking of the silicone composition SZ, the crosslinking takes place preferably thermally, preferably at 80 to 300° C., more preferably at 100-200° C. The duration of the thermal crosslinking is preferably at least 1 minute, more preferably at least 5 minutes, and preferably not more than 2 hours, more preferably not more than 1 hour. Crosslinking with peroxides may take place under inert gas, such as N₂ or Ar, for example, or under air.

Where azo compounds are used for the crosslinking of the silicone composition SZ, the crosslinking takes place preferably thermally, preferably at 80 to 300° C., more preferably at 100-200° C. The duration of the thermal crosslinking is preferably at least 1 minute, more preferably at least 5 minutes, and preferably not more than 2 hours, more preferably not more than 1 hour.

Crosslinking with azo compounds may also take place under irradiation with UV light.

The crosslinking with azo compounds may take place under inert gas, such as N₂ or Ar, for example, or under air.

A feature of the crosslinked membranes (M) is that the degree of crosslinking is >50%, preferably >70%. The degree of crosslinking is defined as the fraction of polymer which no longer dissolves in organic solvents which normally dissolve the silicone elastomers S1.

Examples of such solvents are THF or isopropanol. One appropriate technique for determining the degree of crosslinking is the extraction of the membrane in isopropanol at 82° C. (1.013 bar (abs.)) for 1 h and subsequent gravimetric determination of the insoluble polymer fraction.

One typical technique for modifying or functionalizing the crosslinked membranes (M) is to treat the membranes (M) with high-pressure or low-pressure plasma or with corona discharges.

By holding the membranes (M) in a plasma, the membranes can, for example, be subsequently sterilized, purified or etched using masks.

Likewise preferred, furthermore, is the modification of the membrane surface properties. Here, depending on the plasma method employed, the surface may be hydrophobized or hydrophilized.

The membranes (M), more particularly flat membranes and hollow fiber membranes (M), produced by the above-described phase inversion process and crosslinking have a layer thickness of preferably at least 0.1 μm, more preferably at least 1 μm, more particularly at least 10 μm, better still at least 50 μm, and preferably not more than 2000 μm, more preferably not more than 1000 μm, more particularly not more than 500 μm, better still not more than 250 μm.

After their production, the membranes (M) have a porous structure. Depending on the choice of production parameters, the free volume is at least 5 vol % and at most up to 99 vol %, based on the volume of the silicone composition SZ. Preference is given to membranes (M) having a free volume of at least 20 vol %, more preferably at least 30 vol %, more particularly at least 35 vol %, and preferably not more than 90 vol %, more preferably not more than 80 vol %, more particularly not more than 75 vol %.

The membranes (M) in principle possess an anisotropic construction. A relatively compact outer layer is followed by an increasingly porous polymer framework. The polymer framework is covalently crosslinked.

The selective outer layer may be closed, meaning that there are no pores >1000 Å, as is necessary for use as a gas separation membrane, with a pore size of less than 100 Å, as a membrane for nanofiltration, with a pore size of less than 20 Å, as a membrane for reverse osmosis, with a pore size of less than 10 Å, or as a membrane for pervaporation. In the case of closed, separation-selective layers, the thickness is preferably at least 10 nm, more preferably at least 100 nm, more particularly at least 200 nm, and preferably not more than 200 μm, more preferably not more than 100 μm, more particularly not more than 20 μm.

Any defects present that might adversely influence the separation performance of the membranes (M) can be sealed by what is called a topcoat. Preferred polymers possess a high gas permeability. Particularly preferred polymers are polydimethylsiloxanes. A further possibility for sealing defects on the surface is the thermal treatment of the surfaces. The polymer on the surface melts and thus seals the defects.

A further subject of the invention is the application of the porous crosslinked membranes (M) for the separation of mixtures. Typical compositions of the mixtures for separation include solid-solid, liquid-liquid, gaseous-gaseous, solid-liquid, solid-gaseous, and liquid-gaseous mixtures. Tertiary mixtures as well may be separated using the membranes (M).

The membranes (M) are used preferably to separate gaseous-gaseous, liquid-solid, and liquid-liquid mixtures. The separation in these cases takes place preferably in a single-stage operation or in what are called hybrid operations, in other words two or more separation steps one after another. For example, liquid-liquid mixtures are first purified by distillation, after which separation continues using the porous membranes (M).

The membranes (M) can be used in all membrane processes. Examples of typical membrane processes include reverse osmosis, gas separation, pervaporation, resin infusion in the production of composite materials, nanofiltration, ultrafiltration, and microfiltration.

In these contexts, the membranes (M) are produced in such a way, through the selection of the appropriate production parameters, that the pore structure necessary for the particular application is formed.

In one preferred embodiment of the invention, membranes (M) having a closed, selective layer are obtained, i.e., the pore sizes are preferably in a range of 1-10 Å, suitable with particular preference for the separation of gas mixtures. The anisotropic construction of the membranes (M) allows a significant increase in flow and, in association therewith, in performance, as compared with compact, nonporous silicone membranes. For the separation of the gas mixtures therefore, significantly low quantities of energy are required. The membranes (M) can be produced much more quickly and more favorably, this being absolutely necessary for the industrial use of such membranes (M).

The covalent crosslinking increases the mechanical stability. Furthermore, the stability with respect to solvents or gases that can cause partial dissolution of the membrane is increased, thereby preventing the membrane being damaged or destroyed in the process of separation.

Gaseous-gaseous mixtures which can be separated using the membranes (M) are, for example, O₂/N₂, air, H₂/N₂, H₂O vapor/air, H₂/CO, H₂/CO₂, CO/CO₂, N₂/CO₂, O₂/CO₂, H₂/CH₄, CH₄/CO₂, CH₄/H₂S, CH₄/CnH₂n+2, CH₄/H₂O, gaseous organic compounds/air, or gaseous organic compounds/N₂.

For the separation of volatile organic impurities, also called volatile organic compounds (VOC for short), in wastewaters, the membranes (M) likewise have favorable separation properties. The membranes (M) in this case are used in what are called pervaporation plants. Typical impurities which may be separated from the wastewaters using the membranes (M) are, for example, benzene, acetone, isopropanol, ethanol, methanol, xylene, toluene, vinyl chloride, hexane, aniline, butanol, acetaldehyde, ethylene glycol, DMF, DMAC, methyl ethyl ketone, and methyl isobutyl ketone.

In a further preferred embodiment of the invention, the membrane (M) has pores in a range from 1 nm to 100 nm. These structures are suitable for the production of ultrafiltration membranes. Typical applications of the ultrafiltration membranes (M) are the purification of electrodeposition paint in the automobile industry, protein purification in the food industry, as in the production of cheese or clarification of fruit juices, for example, the purification of oil-in-water emulsions, for the cooling and the lubricating of workpieces, for example, and also the industrial water purification of wastewaters containing particulate impurities, examples being latex residues in the wastewater.

In a further preferred embodiment of the invention, the membrane (M) has pores in a range from 100 nm to 10 μm. These membranes (M) are suitable with particular preference for use in microfiltration units.

Typical applications of the microfiltration membranes (M) are, for example, the removal of bacteria or viruses from water, the sterile filtration of pharmaceutical products, the sterilization of wine and beer, and the production of ultrapure, particle-free water for the electrical industry.

In a further preferred embodiment of the invention, the porous membranes (M) are coated on the surface with an additional polymer.

The additional polymer coating preferably comprises a compact film.

The thickness of the additional layer is guided here by the intended application of the final membrane. The thicknesses of the coatings are situated in a region of preferably at least 10 nm, more preferably at least 50 nm, more particularly at least 100 nm, and preferably not more than 500 μm, more preferably not more than 50 μm, more particularly not more than 10 μm.

Suitable materials for the coating are all polymers which can be processed to films. Examples of typical polymers are cellulose acetate, polyamides, polyimides, polyetherimides, polycarbonates, polybenzimidazoles, polyethersulfones, polyesters, polysulfones, polytetrafluoroethylenes, polyurethanes, silicones, polydimethylsilicones, polymethylphenylsilicones, polymethyloctylsilicones, polymethylalkylsilicones, polymethylarylsilicones, polyvinyl chlorides, polyvinyl alcohols, polyether glycols, polyethylene terephthalate (PET), polyaryletherketones, polyacrylonitrile, polymethyl methacrylates, polyphenylene oxides, polycarbonates, polyethylenes, polypropylenes, and their possible copolymers.

These polymers may be applied to the membranes (M) by customary techniques. Examples of typical coating techniques are laminating, spraying, knife coating, or adhesive bonding. The membrane (M) here must have a surface structure which allows the application of compact and tightly closed films. This can be brought about by measures including through the pore structure of the membrane (M). In one preferred embodiment of the invention, the additional coating is applied to membranes (M) having pores in a range of 10 nm-5 μm. In a particularly preferred embodiment of the invention, the additional coating is applied to membranes (M) having pores in a range of 100 nm-1 μm. As a result of the high permeability and the effective film formation on the surface of the membranes (M), membranes having an overall more effective performance can be obtained. Both the membrane flow and the selectivity of the membranes (M) may be improved further. The stability of the membrane is increased through the covalent crosslinking.

A further application of the membranes (M) is the barrier effect with respect to liquid water in conjunction with water vapor permeability. The membranes (M) in this case may be incorporated, for example, into articles of clothing, such as jackets, for example.

Further examples of applications of the membranes (M) are found in, among other references, Membrane Technology and Applications, second edition, R. W. Baker, New York, Wiley, 2004.

The crosslinking of the membranes (M) significantly improves the mechanical properties of the films. Hence, from the membranes of the prior art it is known that pressure fluctuations in the feed streams can cause tearing of the membranes and hence membrane failure. Thin membranes in particular are very susceptible in this respect. For instance, compact silicone membranes with flows through them that are comparable to those through the membranes (M) have layer thicknesses of around 1 μm to 10 μm. The mechanical instability of these films is such that they can be further-processed at all only by complicated techniques, such as by the application of a thin, compact silicone film on a still water surface, for example. The construction of complicated multilayer composite membranes is absolutely necessary in this case. Furthermore, there is a risk of detachment of the silicone layer from the substrate as a result of the lamination.

With the membranes (M) there is no need for auxiliary constructions of this kind, since the membranes, in addition to the compact and thin selective layer, have a porous, crosslinked understructure which gives the membranes (M) sufficient mechanical stability. The membranes (M) can be processed easily and can be further-processed even without an additional porous support structure. If it proves to be favorable for specific separation applications, the membranes (M) can likewise be applied to porous structures. This may be done either directly on the support—that is, the polymer film is applied to the substrate and immersed thus into the precipitation medium (F), or the membrane (M) is produced and is laminated in a further step onto the support structure. Adhesives used may be, for example, silicone-, acrylate-, epoxy-, poly(urethane)- or poly(olefin)-based adhesives. Optionally it is possible to use adhesion promoters such as silanes, for example, in order to further improve the adhesion of the membranes (M) on the support structures.

The composite material may also be produced by thermal welding of the membrane to the support structure.

The membranes (M) can be installed without problems in membrane modules. Possible in principle in this context is the construction of hollow fiber modules, spiral-wound modules, plate modules, cross-flow modules, or dead-end modules, depending on the form of the membrane (M) as a flat or hollow fiber membrane, respectively. The membranes (M) are easy to integrate into the sequences of the processes that are customary at present, and are also easily integrated with the components necessary in addition to the membrane for the construction of the modules.

All of the above symbols in the above formulae have their definitions in each case independently of one another. In all formulae the silicon atom is tetravalent.

Unless indicated otherwise in each case, all figures for amounts and percentages in the examples below are by weight, all pressures are 1.013 bar (abs.), and all temperatures are 20° C.

Description of the starting compounds used:

Peroxide: tert-butyl peroxypivalate available commercially as a 75% solution in alkanes from United Initiators (Germany).

Si—H crosslinker: copolymer composed of dimethylsiloxane units and hydridomethylsiloxane units, having a molar mass of 4900 g/mol and an Si—H fraction of 4.9 mmol/g Si—H functions (crosslinker V2445 from Wacker Chemie AG).

Pt catalyst: CATALYST EP (1,1,3,3-tetramethyl-1,3-divinyldisiloxane-platinum complex), available commercially from Wacker Chemie AG (Germany).

Inhibitor: 1-ethynyl-1-cyclohexanol, available commercially from Sigma-Aldrich, Germany.

In the examples below, the solubility of the polymer fraction of the membranes produced was determined as follows (“solubility test”):

The section of membrane is dried at 100° C., weighed, and extracted in isopropanol for an hour at 82° C. and 1.013 bar (abs.). Noncrosslinked membranes dissolve completely under these conditions. After an hour, the membrane is dried at 100° C. again and then weighed.

Production of Asymmetrically Porous Membranes from a Knife Coating Solution

A membrane is produced from a knife coating solution, using a knife coating apparatus (Coatmaster 509 MC-I, Erichson). The film drawing frame used is a chamber-type doctor blade with a film width of 11 cm and a slot height of 300 μm. The glass plate substrate used is fixed by means of a vacuum suction plate. Prior to doctor blade application, the glass plate is wiped down with an ethanol-soaked clean-room cloth. In this way any particulate impurities present are removed.

The film drawing frame is subsequently filled with the solution and drawn over the glass plate at a constant film drawing rate of 25 mm/s.

Thereafter, while still liquid, the wet film is immersed into the water-filled inversion tank. The solvent exchange and the uniform precipitation of the polymer can be observed optically during this procedure, via the clouding of the film. The time for the phase inversion is about 1 minute.

After a total of 25 minutes, the membrane is taken from the tank and dried in air. The membrane can be detached readily from the substrate.

### COMPARATIVE EXAMPLE 1

### Production of a Noncrosslinked Asymmetrically Porous Silicone Membrane (not Inventive)

12.9 g of isopropanol are admixed with stirring with 4.2 g of an organopolysiloxane-polyurea copolymer (SLM TPSE 100, Wacker Chemie AG). Then 12.9 g of NMP (N-methylpyrrolidone) are added to the mixture and the entire batch is dissolved at room temperature for 16 hours.

This gives a colorless, viscous solution having a solids content of 14 wt %, referred to below as knife coating solution.

An asymmetric membrane is produced from this knife coating solution in accordance with the protocol described above.

The result is an opaque membrane with a thickness of approximately 67 μm. Under a scanning electron microscope, the anisotropic structure of the membrane is clearly evident. The compact outer layer is adjoined by an open-pore, porous substructure. The overall porosity of the membrane produced in this way is 80 vol %.

The degree of crosslinking in accordance with the solubility test described above is 0 wt %.

### COMPARATIVE EXAMPLE 2

### Production of Compact Films without Porosity (not Inventive)

For the production of compact films, 8.0 g of the organopolysiloxane-polyurea copolymer (SLM TPSE 100, Wacker Chemie AG) are dissolved in 32 g of isopropanol. The film is produced using a knife coating apparatus (Coatmaster 509 MC-I, Erichson).

The film drawing frame used is a chamber-type doctor blade with a film width of 11 cm and a slot height of 300 μm.

The glass plate substrate used is fixed by means of a vacuum suction plate. Prior to the doctor blade application, the glass plate is wiped down with an ethanol-soaked clean-room cloth. In this way any particulate impurities present are removed.

Subsequently the film drawing frame is filled with the solution prepared, and is drawn over the glass plate at a constant film drawing rate of 25 mm/s.

Thereafter the wet film is dried at 60° C. This gives a transparent film having a layer thickness of 30 μm.

### EXAMPLE 1

### Preparation of an Amino-Functional Siloxane Containing Vinyl Groups

3276 g of bishydroxy-terminated polydimethylsiloxane having one vinyl group per molecule and an average molecular weight of 903 g/mol are reacted at 100° C. with 921 g of N-((3-aminopropyl)dimethylsilyl)-2,2-dimethyl-1-aza-2-silacyclopentane. ¹H NMR and ²⁹Si NMR show that after 3 hours, all of the OH groups have undergone conversion to aminopropyl units. The product is purified by means of thin-filming; it has a viscosity of 13 mPas (the flow curve is recorded after conditioning to 25° C. with a plate/cone viscometer, using a 1°/40 mm cone. Following preliminary shearing, the shear stress is raised from 1000 mPa to 5000 mPa in steps of 400 mPa. The resulting shear rates are measured. Evaluation takes place by the method of Newton.).

### EXAMPLE 2

### Preparation of an Organopolysiloxane-Polyurea Copolymer Containing Vinyl Groups

20 g of the amino-functional siloxane containing vinyl groups from example 1, 0.17 g of 2-methylpenta-methylenediamine, 2.52 g of 1,3-bis(1-isocyanato-1-methylethyl)benzene, and 0.9 g of 4,4′-methylenebis-(cyclohexyl isocyanate) are stirred in 170 mL of THF at 80° C. for 3 hours until complete conversion of all the monomers. This produces a highly viscous mass. The solvent is removed at 100° C. and 10 mbar. This gives a transparent polymer having an average molar mass of M_{w}=76 000 g/mol and M_{w}/Mₙ=2.2, measured by GPC (calibrated against polystyrene standard; THF with 0.5% triethylamine as eluant; flow rate 0.7 mL/min; columns: ResiPore and MesoPore 300×7.5 mm; ELSD detector).

### EXAMPLE 3

### Production of a Crosslinked Asymmetrically Porous Silicone Membrane

A solution consisting of 9.2 g of isopropanol and 3 g of organopolysiloxane-polyurea copolymer containing vinyl groups from example 2 is admixed with 9.2 g of NMP (N-methylpyrrolidone), and the overall batch is dissolved at room temperature for 16 hours. This gives a colorless, viscous solution having a solids content of 14 wt %. Then 0.48 g of Si—H crosslinker, 0.06 g of Pt catalyst, and 0.02 g of ethynylcyclohexane are added and the mixture is mixed and degassed on a Speedmixer® DAC 400.1 (from Hauschild, Germany). This knife coating solution is then used to produce an asymmetric membrane in accordance with the protocol described above.

The membrane is crosslinked at 100° C. for 15 minutes. The product is an opaque membrane about 70 μm thick. Under a scanning electron microscope, the anisotropic structure of the membrane is clearly evident. The compact outer layer is joined by an open-pore, porous substructure. The overall porosity of the membrane produced in this way is 80 vol %.

The degree of crosslinking in accordance with the above-described solubility test is 85 wt %.

### EXAMPLE 4

### Production of a Crosslinked Asymmetrically Porous Silicone Membrane on a Polyester Nonwoven Web

In the same way as in example 3, a membrane is fabricated. In this case, however, the substrate used is a polyester web (Novatexx®, 2415N, Freudenberg). The membrane is subsequently crosslinked in analogy to example 3.

This produces a porous membrane which is firmly bonded to the nonwoven web and can no longer be removed from the support without destruction.

The degree of crosslinking in accordance with the above-described solubility test is 89 wt %.

### EXAMPLE 5

### Production of a Crosslinked Asymmetrically Porous Silicone Membrane

A solution consisting of 9.2 g of isopropanol and 3 g of organopolysiloxane-polyurea copolymer containing vinyl groups from example 2 is admixed with 9.2 g of NMP (N-methylpyrrolidone), and the overall batch is dissolved at room temperature for 16 hours.

This gives a colorless, viscous solution having a solids content of 14 wt %. Then 0.1 g of peroxide is added and the mixture is mixed and degassed on a Speedmixer® DAC 400.1 (from Hauschild, Germany). This knife coating solution is then used to produce an asymmetric membrane in accordance with the protocol described above.

The membrane is crosslinked at 100° C. for 15 minutes. The product is an opaque membrane about 69 μm thick. Under a scanning electron microscope, the anisotropic structure of the membrane is clearly evident. The compact outer layer is joined by an open-pore, porous substructure. The overall porosity of the membrane produced in this way is about 85 vol %.

The degree of crosslinking in accordance with the above-described solubility test is 80 wt %.

### EXAMPLE 6

### Determination of the Gas Transport Properties of the Membranes Produced in Example 3 and Comparative Example 2

The various samples are investigated for their different N₂, O₂ and CO₂ gas permeabilities using the GDP-C gas permeability tester (from Brugger, Germany). Prior to the measurement, the two measuring chambers, which are separated by the membrane, are evacuated and then one chamber is flushed with a constant gas flow of 150 cm³/min and the pressure increase in the other chamber is measured. The measurement is conducted at a constant temperature of 20° C.

| | |
|---|---|
| Permeability [barrer] | Selectivity |

| Sample | N₂— | O₂— | CO₂ | N₂/O₂ | CO₂/N₂ |
|---|---|---|---|---|---|
| Example 3 | 1300 | 2600 | 11 200 | 0.5 | 8.6 |
| Comparative | 130 | 390 | 1700 | 0.3 | 13 |
| example 2 | | | | | |

From the table it is clearly apparent that the permeabilities are significantly higher as a result of the anisotropic, porous construction of the membranes of the invention, in comparison to the film produced from solid material. These properties make the membranes of the invention much more efficient than the membranes of the prior art.

### EXAMPLE 7

### Mechanical Investigations of the Membranes and Films from Example 3 and Comparative Example 1

The tensile tests are carried out according to EN ISO 527-3. For the investigation of the mechanical properties, 5 rectangular specimens (6 cm*1 cm) are punched from each of the membranes produced. The specimens produced accordingly are pulled apart at a rate of 0.5 cm/s. The stress-strain curves determined are used in order to determine the modulus of elasticity, the breaking stress, and the elongation at break.

| | Modulus of | Breaking | Elongation |
|---|---|---|---|
| | elasticity | stress | at break |
| | [N/mm⁵] | [MPa] | [%] |
| Comparative | 24.7 | 1.52 | 42 |
| example 1 | | | |
| Example 3 | 27.2 | 2.84 | 76 |

The crosslinked membrane from example 3 exhibits a markedly heightened modulus of elasticity and breaking stress than the noncrosslinked membrane from comparative example 1. Accordingly, the crosslinked membranes are significantly more stable and more load-bearing than the noncrosslinked membranes.

On the basis of the examples given, it is clearly apparent that crosslinked porous membranes made from organopolysiloxane/polyurea/polyurethane/polyamide/polyoxalyldiamine copolymers achieved profiles of properties which significantly exceed the prior art.

1. (canceled)

2. A method for producing covalently crosslinked, asymmetrically porous membranes (M) from thermoplastic silicone elastomers, wherein
in a first step, a solution is prepared from silicone composition SZ, which comprises thermoplastic silicone elastomer S1, comprising alkenyl groups, and crosslinker V, and from solvent L,
in a second step, the solution is brought into a form,
in a third step, the solution brought into form is contacted with a precipitation medium F forming a covalently noncrosslinked membrane,
in a fourth step, solvent L and precipitation medium F are removed from the noncrosslinked membrane, and
in a fifth step, the membrane is subjected to crosslinking, producing the covalently crosslinked membrane MS,
wherein the thermoplastic silicone elastomer S1 used comprises organopolysiloxane/polyurea/polyurethane/polyamide or polyoxalyldiamine copolymer of the general formula (I) 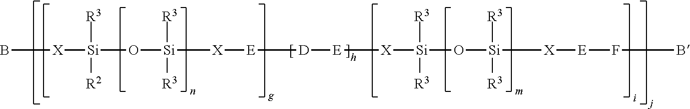
in which the structural element E is selected from the general formulae (Ia-f) 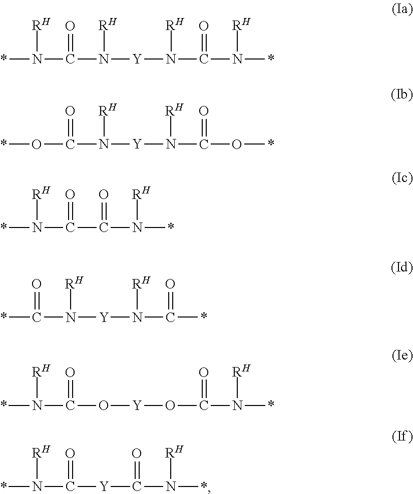
in which the structural element F is selected from the general formulae (IIa-f) 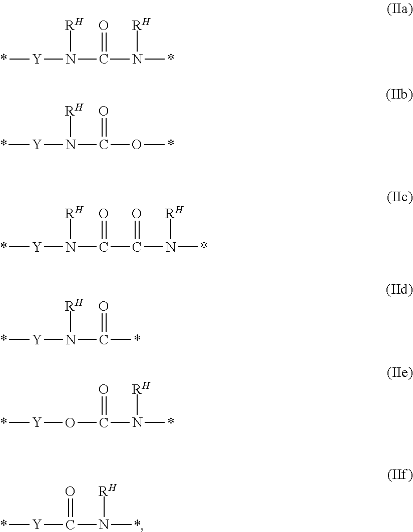
Where
R³ denotes substituted or unsubstituted hydrocarbon radicals which may be interrupted by oxygen or nitrogen atoms,
R^{H} is hydrogen or has the definition of R³,
X is an alkylene radical having 1 to 20 carbon atoms, in which methylene units not adjacent to one another may be replaced by —O— groups or is an arylene radical having 6 to 22 carbon atoms,
Y is a divalent hydrocarbon radical optionally substituted by fluorine or chlorine and having 1 to 20 carbon atoms,
D is an alkylene radical which is optionally substituted by fluorine, chlorine, C₁-C₆ alkyl or C₁-C₆ alkyl ester and which has 1 to 700 carbon atoms, in which methylene units not adjacent to one another may be replaced by —O—, —COO—, —OCO—, or —OCOO— groups, or is an arylene radical having 6 to 22 carbon atoms,
B, B′ denote a reactive or nonreactive end group which is bonded covalently to the polymer,
m is an integer from 1 to 4000,
n is an integer from 1 to 4000,
g is an integer which is at least 1,
h is an integer from 0 to 40,
i is an integer from 0 to 30, and
j is an integer greater than 0,
with the proviso that at least two radicals R³ per molecule comprise at least one alkenyl group.

3. (canceled)

4. The method as claimed in claim 24, wherein the radicals R³ comprising alkenyl groups are alkenyl radicals having 2 to 12 carbon atoms.

5. The method as claimed in claim 2, wherein the crosslinker V is selected from the group consisting of organosilicon compounds comprising at least two SiH functions per molecule, peroxides, and azo compounds.

6. The method as claimed in claim 2, wherein the form in the second step is a film or a hollow fiber.

7. The method as claimed in claim 2, wherein, in the third step, the solutions brought into form are immersed into a precipitation bath filled with precipitation medium F.

8. The method as claimed in claim 2, wherein, in the fourth step, residues of solvent L and precipitation medium F are removed from the noncrosslinked membrane by evaporation.

9. Covalently crosslinked, asymmetrically porous membranes (M) made of thermoplastic silicone elastomers, producible by the method as claimed in claim 2.

10. The use of the membranes (M) as claimed in claim 9 for separating mixtures or for coating.

11. The method as claimed in claim 4, wherein the crosslinker V is selected from the group consisting of organosilicon compounds comprising at least two SiH functions per molecule, peroxides, and azo compounds.

12. The method as claimed in claim 11, wherein the form in the second step is a film or a hollow fiber.

13. The method as claimed in claim 12, wherein, in the third step, the solutions brought into form are immersed into a precipitation bath filled with precipitation medium F.

14. The method as claimed in claim 13, wherein, in the fourth step, residues of solvent L and precipitation medium F are removed from the noncrosslinked membrane by evaporation.

15. Covalently crosslinked, asymmetrically porous membranes (M) made of thermoplastic silicone elastomers, producible by the method as claimed in claim 14.
